(19) United States
(12) Patent Application Publication
(10) Pub. No.: US 2003/0014900 A1
(43) Pub. Date: Jan. 23, 2003

(54) Sinker for fishing

(76) Inventor: Kang Shang Keu, Gyeongsangnam-do (KR)

Correspondence Address: Diane Dunn McKay, Esq., Mathews, Collins, Shepherd & Gould, P.A., Suite 306, 100 Thanet Circle, Princeton, NJ, 08540, US

(21) Appl. No.: 10/192,138

(22) Filed: Jul. 10, 2002

(30) Foreign Application Priority Data
Jul. 13, 2001 (KR) 2001-0021370

(51) Int. Cl. A01K 91/00; A01K 93/00; A01K 95/00

(52) U.S. Cl. 43/44.9

(57) ABSTRACT

The present invention is directed to a fishing sinker for sinking a fishing hook or fishing net in water, and the object thereof is to provide the sinker for fishing, which prevents catching in water so as to avoid an economic loss, and prevents water pollution even if it is lost. The sinker according to the present invention comprises a body having a through hole, a coating for covering an outer surface of the body and an inner surface of the through hole, and a plurality of elastic projections formed radially and integrally on the coated outer surface.

### BACKGROUND OF THE INVENTION

1. Field of the Invention

The present invention relates to a fishing sinker for sinking a fishing hook or fishing net in water, more specifically the sinker in which an inner and outer surface of a body is coated with a rubber material and a plurality of elastic projections are formed integrally on the outer surface of the body.

2. Background of the Related Art

Generally, a sinker is classified into a small sized sinker for fishing hook that is attached a fishing line and a large sized sinker for net that is attached to an lower end of the net, and the sinker is mostly made of lead material that has great specific gravity so as not to be affected by buoyancy.

The sinker, as shown in FIG. 6 comprises integral body 1 having an elliptical cross section and a through hole 2 formed along longitudinal centerline so that it could be attached easily by being threaded with a line.

When the sinker attached to the fishing line is dropped into water, it is frequently caught between the small rocks or shingles due to a small surface area, and therefore is detached when the line is drew.

Especially, at a place such as bedrock where the many obstacles usually exist as well as many fish reside, the more sinker are caught therein and lost more frequently, and at the same time other fishing equipments connected with sinker are also lost.

In addition, when the sinkers are attached to the net, the sinker are caught between rocks or shingles so that the net is tore off or the sinker are lost frequently.

When the sinkers are lost, an economic loss arises and attaching a new sinker again is cumbersome. Also, the sinkers made of lead cause water pollution and therefore destroy an underwater ecosystem.

### SUMMARY OF THE INVENTION

The present invention is contemplated to solve the aforementioned problem, and it is an object of the present invention to provide a sinker for fishing, which prevents catching in water so as to avoid an economic loss, and prevents water pollution, if lost.

To accomplish the above object, the present invention provides a sinker for fishing comprising: a body having a through hole; a coating for covering an outer surface of the body and an inner surface of the through hole; and a plurality of elastic projections formed radially and integrally on the coated outer surface.

Preferably, the body is made of metal of great specific gravity.

The sinker of the present invention as described is used as a sinker for hook or a sinker for net, and has elastic projections with a predetermined length so that it is not detached by being caught between rocks or shingles in water and even if lost, does not occur water pollution due to the coating of raw material.

### BRIEF DESCRIPTION OF THE DRAWINGS

The features and advantages of the present invention will be more described specifically in the following description of preferred embodiments of the invention with reference to the accompanying drawings wherein:

FIG. 1 is a perspective view of a sinker for fishing according to the present invention;

FIG. 2 is a sectional view of FIG. 1;

FIG. 3 -FIG. 5 are views showing an usage of a fishing sinker according to the present invention; and

FIG. 6 is a perspective view showing a sinker for fishing of prior art.

### DETAILED DESCRIPTION OF THE PREFERRED EMBODIMENT

Reference will now be made in detail to the first and second embodiment of the present invention, examples of which are illustrated in the accompanying drawings. In explaining the present invention, the same names and reference numerals will be given to the same components, and explanations in the same will be omitted.

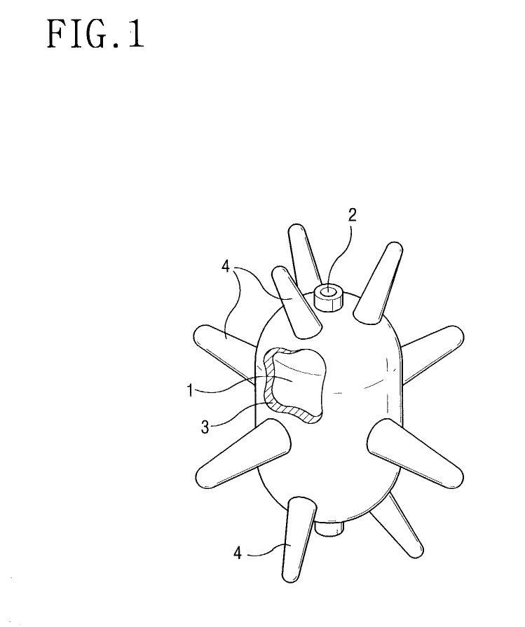

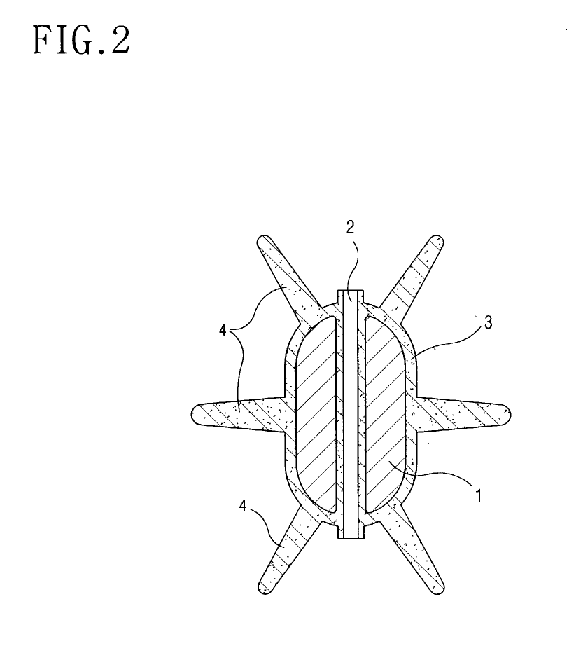

FIG. 1 is a perspective view of a sinker for fishing according to the present invention, and FIG. 2 is a sectional view of FIG. 1.

In the embodiment of the present invention, the sinker comprises a body 1 formed with a through hole 2, similar to prior art. However, in the present invention, an entire inner and outer surface of the body 1 is coated thin with raw rubber and the plurality of elastic projections 3 with a predetermined length are formed radially on the outer surface.

The body 1 is made of a lump of metal or metallic material of powder or granule that has great specific gravity. It is preferable for the body 1 not to be made of lead that is heavy metal.

This is to prevent severe water pollution due to the usage of heavy metal such as lead, if the sinker is lost in water and the coating is removed.

A coating 3 made of raw rubber covers the outer surface of the body 1 and an entire surface of the through hole 2, that is the outer and inner surface of the body 1 by the injection molding so that the body 1 is sealed completely not to be exposed.

The cross section of the sinker is preferably elliptical similar to that of prior art, and a plurality of the elastic projections 4 is formed radially and integrally on an outer surface of the coating 3 made of raw rubber.

The elastic projections 4 have a predetermined length, and preferably as shown in FIG. 1, three projections are located on an upper and lower part of the sinker and four projections are located on a middle part. In addition, the elastic projections 4 characteristically support the weight of the sinker with not being deformed and they are bended when the external force is exerted thereon.

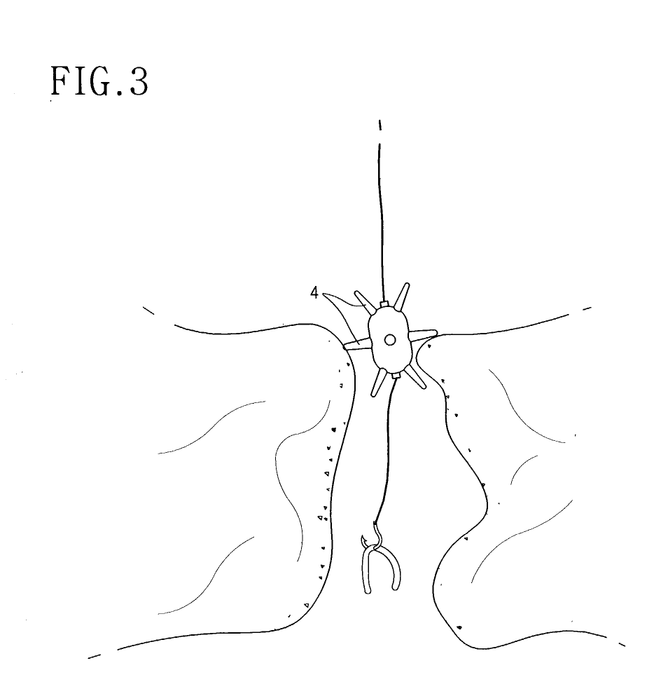

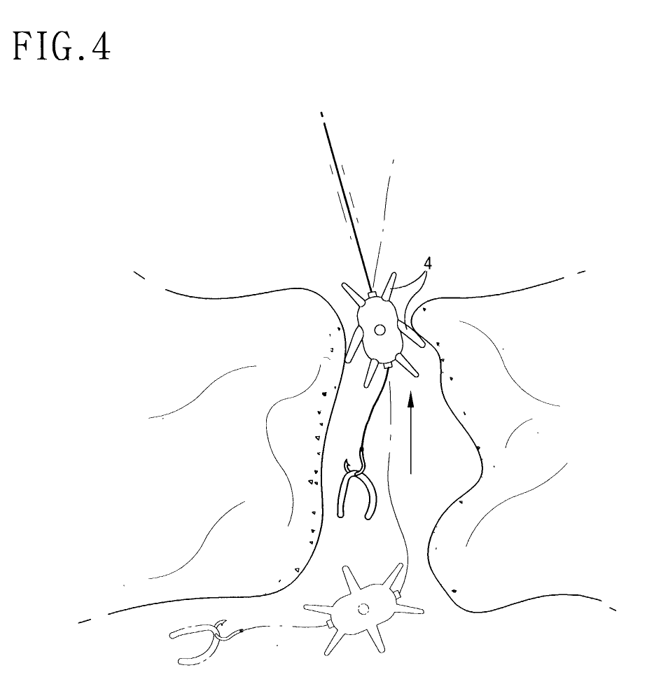

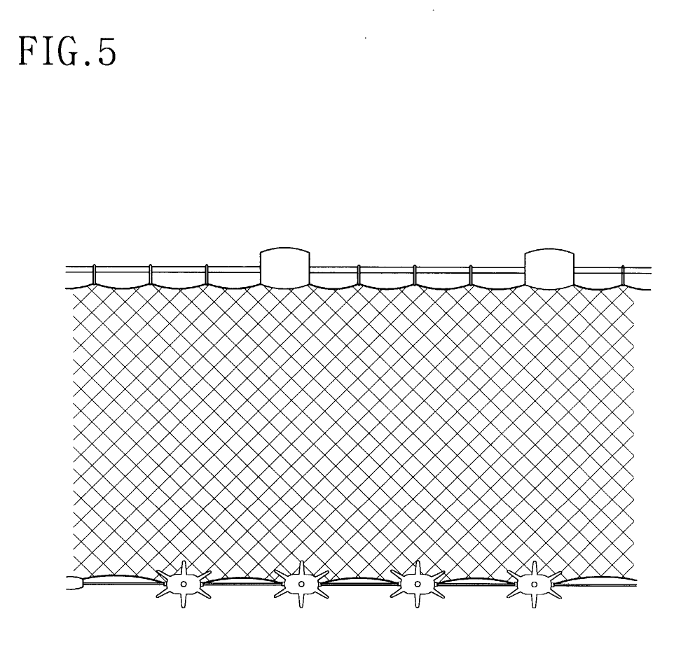

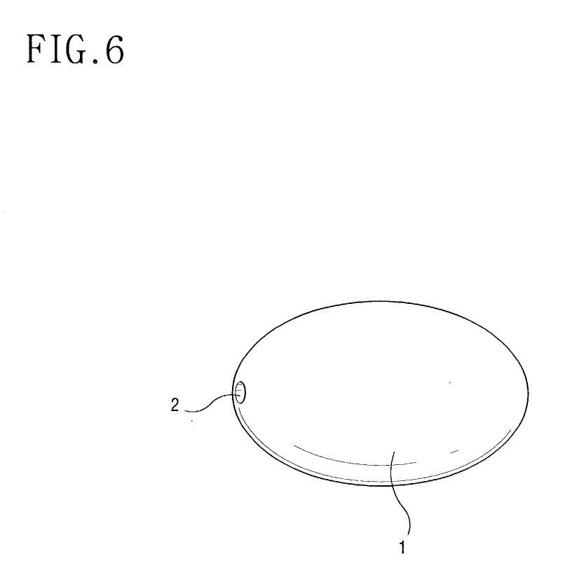

When the fishing sinker of the present invention is applied to fishing line as shown in FIG. 3, the sinker is not caught easily between small rocks due to the elastic projections 4. If the sinker passes through a relatively wide gap between the rocks as shown in FIG. 4, the sinker could escape therefrom due to the deformation of the projections 4 when the fishing line is drew.

Further, as shown in FIG. 5, when the fishing sinker of the present invention is applied to fishing net, the sinkers are not caught by shingles of bottom in water so that the net is not tore up and the sinkers are not lost.

Meanwhile, the sinker could be made of other materials that do not occur water pollution, and a coating could be made of synthetic resins having elasticity as well as raw rubber.

The advantages of the present invention are summarized as follows.

As described above, the sinker of the present invention is not caught easily between rocks and could escape therefrom if caught so that the number of lost sinker is decreased and also the economic loss is decreased. In addition. If the sinkers are lost, the water pollution due to the heavy metal and oxidization is prevented since the body od the sinker is covered with the coating.

Although a number of embodiment have described in the above specification, it should be apparent that the present invention could be embodied in many other specific mode included within the sprit and scope of the present invention. Thus, the present embodiments should be considered as illustrative, and the present invention could be modified within the scope of claims and the equivalent thereof.

What is claimed is:

1. A sinker for fishing comprising:
a body having a through hole;
a coating for covering an outer surface of the body and an inner surface of the through hole; and
a plurality of elastic projections formed radially and integrally on the coated outer surface.

2. The sinker according to claim 1, wherein the body is made of metal that has great specific gravity.
